(19) United States
(12) Patent Application Publication
(10) Pub. No.: US 2008/0138699 A1
(43) Pub. Date: Jun. 12, 2008

(54) Jelly roll electrode assembly and secondary battery using the assembly

(76) Inventors: Jinhee Kim, Yongin-si (KR); Sangok Lee, Yongin-si (KR); Wanmook Lim, Yongin-si (KR)

Correspondence Address: ROBERT E. BUSHNELL, 1522 K STREET NW, SUITE 300, WASHINGTON, DC, 20005-1202, US

(21) Appl. No.: 11/987,897

(22) Filed: Dec. 5, 2007

(30) Foreign Application Priority Data
Dec. 7, 2006 (KR) 10-2006-0123897
Apr. 24, 2007 (KR) 10-2007-0039968

(51) Int. Cl. H01M 4/00; H01M 10/36

(52) U.S. Cl. 429/94

(57) ABSTRACT

A jelly roll electrode assembly, including a ceramic separator instead of a film separator and a secondary battery using the assembly, can be easily wound by forming a long non-coating portion of plate instead of the film separator to prevent cross-winding of the electrode assembly and the mandrel due to a friction by separating the wound electrode assembly from the mandrel, and to improve reliability. The jelly roll electrode assembly, including a positive electrode plate and an negative electrode plate, includes: a ceramic layer coated on at least one of the positive electrode plate or the negative electrode plate to prevent an electrical short between the positive electrode and negative electrode plates; a non-coating portion of the positive electrode and negative electrode plates, having no active material coated thereon, and an extended contact part, of the same electrode material as the non-coating portion, extending from one end of the non-coating portion of the positive electrode plate or the negative electrode plate to contact a mandrel during winding of the assembly.

### CLAIM OF PRIORITY

This application makes reference to, incorporates the same herein, and claims all benefits accruing under 35 U.S.C. §119 from an application for JELLY ROLL TYPE ELECTRODE ASSEMBLY AND SECONDARY BATTERY WITH THE SAME earlier filed in the Korean Intellectual Property Office on 7 Dec. 2006 and 24 Apr. 2007 and there duly assigned Serial No. 10-2006-123897 and 10-2007-39968 respectively.

### BACKGROUND OF THE INVENTION

1. Field of the Invention

The present invention relates to a jelly roll electrode assembly and a secondary battery using the assembly, and more particularly, the present invention relates to a jelly roll electrode assembly in which a separator formed of a ceramic layer is interposed between a positive electrode plate and a negative electrode plate and a secondary battery using the assembly.

2. Description of the Related Art

Generally, a secondary battery can be used repeatedly, if it is recharged, differently from a disposable battery. The secondary battery has been usually used as a main power source of portable devices for communication, information processing and audio/video. Recently, the secondary battery has been rapidly developed because it has ultra-light weight, high energy density, a high output voltage, a low self-discharging rate, environment-friendliness and a long lifetime as a power source.

The secondary battery is divided into a nickel-hydrogen (Ni-MH) battery and a lithium ion (Li-ion) battery according to electrode active materials. Particularly, the lithium ion battery can be also divided into a lithium ion battery using a liquid electrolyte and a lithium ion polymer battery using a solid polymer electrolyte or a lithium ion battery using a gel type electrolyte according to electrolyte type. Furthermore, the lithium ion battery can be divided into various types such as a can shaped battery and a pouch shaped battery according to a shape of a container receiving an electrode assembly.

The lithium ion battery can implement an ultra-light battery because its energy density per weight is much higher than a disposable battery. An average voltage per a cell of the lithium ion battery is 3.6V, i.e., three times that of the average voltage 1.2V of other rechargeable batteries, such as a Nicad battery or a nickel-hydrogen battery. The self-discharging rate of the lithium ion battery is less than about 5% a month at 20° C., which is about ⅓ of that of the Nicad battery or the nickel-hydrogen battery. The lithium ion battery is environment-friendly because it does not use heavy metals, such as cadmium (Cd) or mercury (Hg), and has an advantage in that it can be charged/discharged more than 1000 times under normal conditions. Accordingly, the lithium ion battery has been rapidly developed with the growth of an information and communication technology.

In a conventional secondary battery, a bare cell is formed by receiving an electrode assembly including a positive electrode plate, a negative electrode plate and a separator in a can made of aluminum or aluminum alloy, finishing an opening of an upper end of the can with a cap assembly, injecting electrolyte into the inside of the can and sealing the can. Because the can is made of aluminum or aluminum alloy, it has advantages in that it can be light-weight due to aluminum being lightweight and does not corrode even when it is used for a long time under a high voltage.

The sealed unit bare cell is received in a separate hard pack and is connected to safety devices, such as a PTC (Positive Temperature Coefficient) device, a thermal fuse, a Protective Circuit Module (PCM) and other accessories. Or, its external shape may be formed by a mold made of hot melt resin.

The separator of the electrode assembly, which is an olefin type film separator, is installed between the positive electrode plate and the negative electrode plate in order to prevent an electrical short between the two electrodes. However, when the separator existing between the two electrodes does not have sufficient permeability and wettability for the electrolyte, there is a problem in that the separator restricts movement of lithium ions between the two electrodes so that an electrical property of the battery is degraded.

Furthermore, the separator functions as a safety device for preventing the battery from being overheated. However, when the battery temperature is suddenly increased due to certain reasons, for example, external heat transfer, etc., the separator may be damaged by the battery temperature increased continuously for a predetermined time even though micro-pores of the separator are closed.

In addition, if the capacity of the battery becomes higher by a high density coating portion to increase the density of an electrode plate, there is a problem in that the injecting speed of an electrolyte becomes low or a required amount of the electrolyte is not injected because the electrolyte does not sink into the electrode plate.

When the battery is continuously charged/discharged, a by-product is produced by redox reaction between positive electrode and negative electrode active materials and the electrolyte and thus, the electrolyte is continuously exhausted. Accordingly, if absolute amount of the electrolyte as a media for ion movement between the positive electrode and the negative electrode is not fulfilled, the capacity of a cycle is decreased.

Additionally, when a large current flows in the secondary battery for a short time according to the high capacity of the battery, there is a problem in that the possibility of an electrical short due to a damage of the separator is increased because the separator is continuously melted by previously generated heat, rather than the battery temperature being decreased by current shutdown, even if micro-pores of the separator are closed.

According to a request for stably preventing the electrical short between the electrodes even under a high temperature, the separator includes a ceramic separator including a porous membrane formed by combining ceramic filler particles with a heat-resistant binder.

On the other hand, when an electrode assembly is manufactured by using an olefin film separator as a separator, as shown in FIG. 4, a core of a jelly roll is formed by winding a film separator 30 by 1 to 3 times turns at the time of winding. The jelly roll is separated from a mandrel after winding. The jelly roll can be easily separated from the mandrel because a friction coefficient of the separator 30 is low.

To the contrary, when an electrode assembly is manufactured using the ceramic separator without using the olefin type film separator, winding is difficult because positive electrode and negative electrode plates form a core of a jelly roll while non-coating portions of the positive electrode and negative electrode plates are first wound by a mandrel at the time of winding. In addition, when the jelly roll is separated from the mandrel, there is a problem that a cross-winding phenomenon of the electrode assembly and the mandrel occurs caused due to friction because the jelly roll is not easily separated on account of a high friction coefficient of the ceramic separator coated on a non-coating portion.

### SUMMARY OF THE INVENTION

Accordingly, an object of the present invention is to provide a jelly roll electrode assembly including a ceramic separator instead of a film separator and a secondary battery using the assembly, which can be easily wound by the same method as winding first the conventional film separator several turns.

Another object of the present invention is to provide a jelly roll electrode assembly and a secondary battery using the assembly, which have high reliability by easily separating the wound electrode assembly from a mandrel so as to prevent a cross-winding phenomenon of the jelly roll electrode assembly and the mandrel.

Still another object of the present invention is to provide a jelly roll electrode assembly and a secondary battery using the assembly, which can rapidly absorb an electrolyte so as to improve the electrolyte injecting speed and improve lifetime and high rate discharge and low temperature characteristics due to an excellent electrolyte-holding property.

Additional advantages, objects and features of the present invention are set forth in part in the description which follows and in part will become apparent to those having ordinary skill in the art upon examination of the following or may be learned from practice of the invention.

According to one aspect of the present invention, a jelly roll electrode assembly including a positive electrode plate and a negative electrode plate is provided, the assembly including: a ceramic layer coating at least one of the positive electrode plate or the negative electrode plate to prevent an electrical short between the positive electrode and negative electrode plates; a non-coating portion arranged on both the positive electrode and negative electrode plates, the non-coating portion having no coated material; and an extended contact part of the same electrode material as the non-coating portion, the extended contact part extending from one end of the non-coating portion of either the positive electrode plate or the negative electrode plate to contact a mandrel during winding of the assembly.

The extended contact part may have length to be wound from 1 to 3 times during winding of the assembly. The extended contact part may have a length in a range of 1 cm to 10 cm.

A polymer may coat the extended contact part. A resin insulator may be attached to the extended contact part.

The ceramic layer may be coated on either the positive electrode plate or the negative electrode plate and may include a ceramic paste including an inorganic oxide filler with a binder and a solvent.

The inorganic oxide filler may include a semiconductor filler including a band gap. The inorganic oxide filler may include one of alumina (Al₂O₃) or zirconia (ZrO₂) or titanium oxide (TiO₂) or silica (SiO₂).

The binder may include an acrylate rubber group binder. The binder may include a water-based binder corresponding to an organic binder of the coating portion coated on either the positive electrode plate or the negative electrode plate. The water-based binder may include a SBR group binder.

A solvent to be mixed with the water-based binder may include NMP or isopropyl alcohol or toluene or xilen.

The binder may include an organic binder corresponding to the water-based binder of the coating portion coated on either the positive electrode plate or the negative electrode plate. The organic binder may include PVDF group binder.

A solvent to be mixed with the organic binder may include water.

According to another aspect of the present invention, a secondary battery including a jelly roll electrode assembly, a can and a cap assembly is provided, the battery including: a ceramic layer coating at least one of two electrode plates included in the jelly roll electrode assembly to prevent an electrical short between the two electrode plates, the two electrode plates each having a non-coating portion having no active material coated thereon; and an extended contact part of the same electrode material as the non-coating portion, the extended contact part extending from one end of one non-coating portion of the two electrode plates to contact a mandrel during winding of the assembly.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a construction view of a jelly roll electrode assembly according to one exemplary embodiment of the present invention;

FIG. 2 is a sectional view taken along A-A line of FIG. 1;

FIG. 3 is a sectional view of a negative electrode plate according to one exemplary embodiment of the present invention; and

FIG. 4 is a construction view of a jelly roll electrode assembly.

### DETAILED DESCRIPTION OF THE INVENTION

Hereinafter, exemplary embodiments of the present invention are described in detail with reference to the accompanying drawing. The aspects and features of the present invention and methods for achieving the aspects and features will be apparent by referring to the embodiments described in detail with reference to the accompanying drawings. However, the present invention is not limited to the embodiments disclosed hereinafter, but can be implemented in diverse forms. The matters defined in the description, such as the detailed construction and elements, are merely specific details provided to assist those of ordinary skill in the art in a comprehensive understanding of the present invention, and the present invention is only defined within the scope of the appended claims. In the entire description of the present invention, the same drawing reference numerals are used for the same elements across various figures.

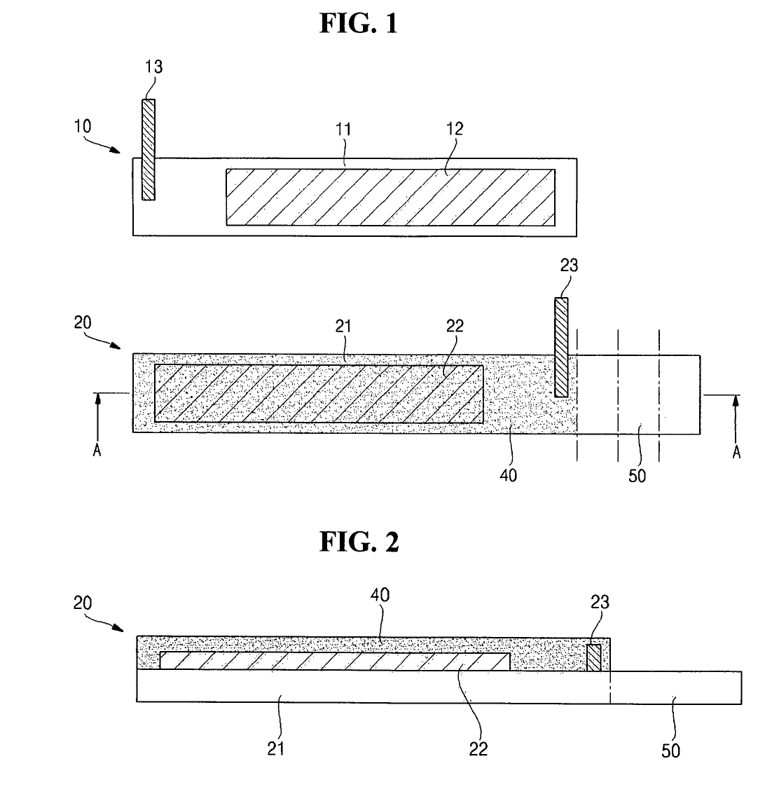

Referring to FIG. 1, a jelly roll electrode assembly according to one exemplary embodiment of the present invention includes a positive electrode plate 10, a negative electrode plate 20, and a separator interposed between the positive electrode plate 10 and the negative electrode plate 20 for preventing an electrical short between the positive electrode plate 10 and the negative electrode plate 20 and enabling only lithium ions to be transferred, where the positive electrode plate 10, the separator and the negative electrode plate 20 are laminated and wound.

The positive electrode plate 10 includes a positive electrode collector 11, a positive electrode coating portion 12, and a positive electrode tap 13.

The positive electrode collector 11 is formed of thin aluminum foil. The positive electrode coating portion 12 consisted of lithium oxide as a main component is coated on both surfaces of the positive electrode collector 11. Furthermore, a positive electrode non-coating portion, a region where the positive electrode coating portion 12 is not formed, is formed at both ends of the positive electrode current collector 11.

Lithium oxides, such as LiCoO₂, LiMn₂O₄, LiNiO₂ and LiMnO₂, etc. are used for the positive electrode coating portion 12.

The positive electrode tap 13 is fixed at the positive electrode non-coating portion located at an inner circumference at the time of winding by ultrasonic welding or laser welding. The positive electrode tap 13 is formed of nickel, and is fixed so that its upper end protrudes above an upper end of the positive electrode collector 11.

Referring to FIGS. 1 and 2, the negative electrode plate 20 includes a negative electrode collector 21, an extended contact part 50, a negative electrode coating portion 22, and a negative electrode tap 23.

The negative electrode collector 21 is formed of thin copper foil, and the negative electrode coating portion 22, consisting of carbon materials as a main component, is coated on both surfaces of the negative electrode collector 21. Furthermore, a negative electrode non-coating portion, a region where the negative electrode coating portion 22 is not formed, is formed at both ends of the negative electrode collector 21.

The extended contact part 50 is formed at one end of the negative electrode non-coating portion so as to contact a mandrel at the time of winding. The extended contact part 50 is formed of a thin copper foil plate made of the same substrate as the negative electrode non-coating portion. On the other hand, the extended contact part 50 maybe formed of a thin aluminum foil plate (not shown) made of the same substrate as the positive electrode non-coating portion, which may be formed at one end of the positive electrode non-coating portion.

The extended contact part 50 may be formed so that it is first wound by 1 to 3 times turn by the mandrel at the time of winding and forms a core of the jelly roll. Particularly, the extended contact part 50 may have a length of 1 cm to 10 cm. The length is same as the length in which a conventional olefin type film separator is wound by the mandrel at the time of a first winding. The extended contact 50 part may have the same length as that of the olefin type film separator at the time of the first winding.

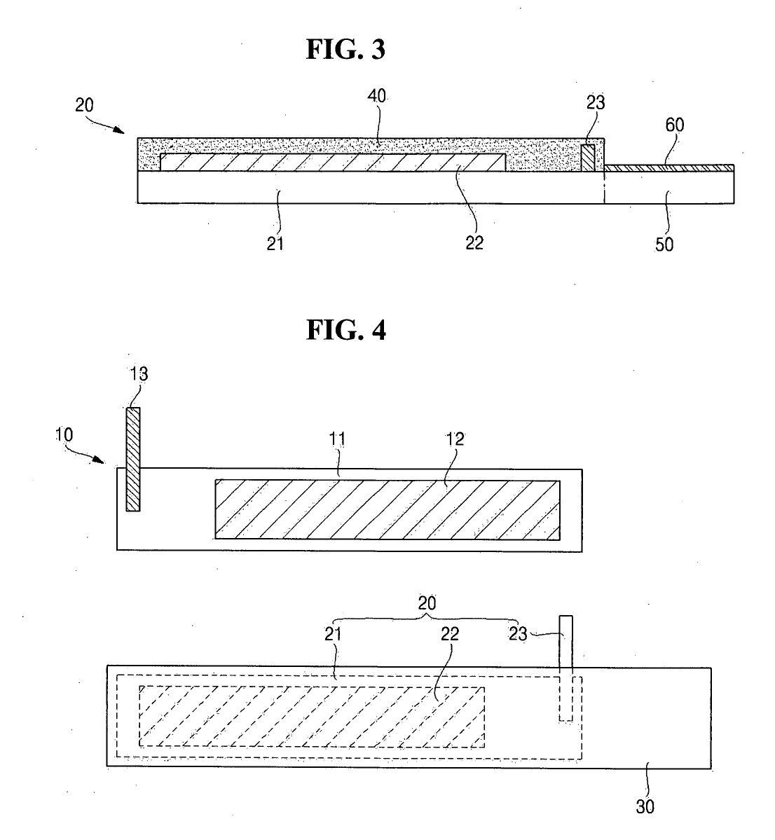

On the other hand, when a friction coefficient of the extended contact part 50 is high, the jelly roll cannot be easily separated from the mandrel after winding. Accordingly, in order to solve the problem, a copper foil having a low friction coefficient may be used, or even when a copper foil having a high friction coefficient is used, a polymer layer having a low friction coefficient may be formed on the extended contact part 50, thereby allowing the jelly roll to be easily separated from the mandrel. That is, as shown in FIG. 3, a polymer 60 may be formed on the extended contact part 50, or a resin insulator may be attached on the extended contact part 50, thereby allowing the jelly roll to be easily separated from the mandrel.

Carbonic(C) material, silicon, tin, tin oxide, composite tin alloys and transition metal oxide, etc. are used for the negative electrode active material 22.

The negative electrode tap 23 is made of nickel and attached to the negative electrode non-coating portion located at an inner circumference at the time of winding by ultrasonic welding. The negative electrode tap 23 is attached so that its upper end protrudes above an upper end of the negative electrode collector 21.

The separator is formed of only a ceramic layer 40. The ceramic layer 40 is formed by coating a ceramic paste, which is made by mixing an inorganic oxide filler with a binder and a solvent for ceramic, on each positive electrode plate 10 or negative electrode plate 20 or on both plates. In the embodiment, as shown in FIGS. 1 to 3, the ceramic layer 40 is coated on one surface of the negative electrode plate 20.

The ceramic separator formed of only a ceramic layer 40 has the same function as the conventional olefin film separator. The ceramic layer 40 prevents an electrical short between the positive electrode plate 10 and the negative electrode plate 20 because it is an electrical insulator and has no electrical conductivity. Simultaneously, because the ceramic layer is highly porous due to the property of the ceramic powder, it rapidly absorbs the electrolyte so as to increase the injecting speed of the electrolyte and has excellent electrolyte-holding property, thereby allowing lifetime and high rate discharge characteristics of the battery to be improved.

Table 1 represents porosities of the conventional olefin type film separator and the ceramic layer. After the ceramic paste has been made and coated on the negative electrode plate, the porosity of the ceramic layer was measured by a Hg porosimeter.

The porosities of ceramic layers 4 to 7 are larger than those of polypropylene (PP) or polyethylene (PE) separators 1 to 3, which are olefin type film separators.

TABLE 1

| | Separator | porosity (%) |
|---|---|---|
| 1 | PP-PE-PP 3 layers separator | 38 |
| 2 | PE single layer separator | 41 |
| 3 | PP single layer separator | 45 |
| 4 | Alumina (Al₂O₃) ceramic layer | 72 |
| 5 | Titan oxide (TiO₂) ceramic layer | 68 |
| 6 | Zirconia (ZrO₂) ceramic layer | 66 |
| 7 | Silica (SiO₂) ceramic layer | 65 |

The inorganic oxide filler may be a semiconductor filler having a band gap, or may be formed of alumina (Al₂O₃) or zirconia (ZrO₂) or titanium oxide (TiO₂) or silica (SiO₂).

The semiconductor filler having a band gap includes a-alumina (Al₂O₃), which has an effect of preventing an overcharge. That is, when a ceramic layer formed of a-alumina (Al₂O₃) having a band gap coated on an negative electrode plate is overcharged under a high temperature, lithium metal is finely educed through pores. When lithium metal is educed in the a-alumina (Al₂O₃) layer, the lithium metal educed in the a-alumina (Al₂O₃) layer has a negative (−) charge and a surface of a-alumina (Al₂O₃) layer has a positive (+) charge in comparison with the lithium metal. Accordingly, lithium ion Li+ leaked out of positive electrode active material at the time of overcharge are prevented from flowing into the negative electrode by the a-alumina (Al₂O₃) layer having a positive (+) charge. The overcharge of the battery is not continued by the ion blocking phenomenon, as noted above, and thus, ignition and explosion of the battery can be prevented.

The binder may be a polymer resin, such as acrylate polymer or methacrylate polymer, which is one of the acrylate rubber group and resistant to heat of more than 200° C., or their copolymers. It is processed so as to be present at a normal temperature in the form of an oligomer that is an intermediate state between a monomer and a polymer, and preserved as a mixture with a solvent, that is, a binder solution and used for preparing a paste.

The binder may be used in small amounts in a slurry for forming a ceramic layer. Particularly, if a mass ratio of ceramic material to the binder in the ceramic layer is in the range of (98 to 2) to (85 to 15), the inorganic oxide filler can be prevented from being completely covered by the binder. In other words, the problem can be solved in that ions transferring into the inorganic oxide filler are restricted by the binder covering the inorganic oxide filler.

When the ceramic layer is formed on the negative electrode plate, an organic binder may be used as the ceramic binder for the ceramic layer if the binder of the negative electrode coating portion is a water-based binder. However, if the binder of the negative electrode coating portion is an organic binder, a water-based binder may be used as the ceramic binder for the ceramic layer. The water-based binder may be an SBR group binder, and the organic binder may be a PVDF group binder. As described above, the reason for changing the ceramic binder according to the kind of the binder of the negative electrode coating portion is that a previously dried and formed coating portion may be re-melted in the solvent in the ceramic paste when the ceramic paste is coated on a previously formed coating portion because when the same organic binder or water-based binder is used for the coating portion and the ceramic layer, the same organic or water-based solvent as the binder should be used.

The solvent is changed according to the kind of the ceramic binder. That is, when an organic binder is used as the ceramic binder, NMP and cyclohexanon may be used in composition ratio of (0 to 100) to (50:50) as the solvent, or, isopropyl alcohol or toluene or xilen may be used instead of NMP.

On the other hand, when a water-based binder is used as the ceramic binder, water may be used as the solvent.

Table 2 represents wettability, electrolyte holding property, electrolyte injecting speed, injecting volume, high rate charge/discharge property, low temperature discharge property and cycle capacity maintenance ratio of electrodes coated with ceramic layers formed of various inorganic oxide fillers.

TABLE 2

| | | | Measured in a state of electrode plate | | | | | | | |
|---|---|---|---|---|---|---|---|---|---|---|
| | | | | | Weight | | | | | |
| | | | | | increase % | Measured after battery manufacture | | | | |
| | | | Diameter | | after | Injecting | Electrolyte | | | |
| | | | mm | Height | immersed in | time | amount | 5 C. | 20° C. | Lifetime |
| | | | of spread | mm of | electrolyte | sec of | g injected | discharge | discharge | at 500 |
| | positive | negative | electrolyte | chromatography | and taken | electrolyte | during | capacity | capacity | cycles |
| | electrode | electrode | (0.3 g) | (5 min) | out | 3 g | 3 min | (%) | (%) | (%) |
| Comparative | — | | 20 (positive | 3 (positive | 5 (positive | 420 | 2.02 | 30 | 15 | 65 |
| example | | | electrode) | electrode) | electrode) | | | | | |
| | | | 25 (negative | 5 (negative | 6 (negative | | | | | |
| | | | electrode) | electrode) | electrode) | | | | | |
| example 1 | Alumina | | 42 | 56 | 7.1 | 205 | 3.51 | 65 | 35 | 88 |
| | coating | | | | | | | | | |
| example 2 | Titan | | 45 | 63 | 7.7 | 204 | 3.42 | 64 | 36 | 85 |
| | oxide | | | | | | | | | |
| | coating | | | | | | | | | |
| example 3 | Zirconia | | 43 | 75 | 7.6 | 285 | 3.52 | 63 | 37 | 86 |
| | coating | | | | | | | | | |
| example 4 | Silica | | 42 | 65 | 8 | 278 | 3.40 | 72 | 39 | 87 |
| | coating | | | | | | | | | |
| example 5 | — | Alumina | 53 | 59 | 9.5 | 299 | 3.10 | 71 | 31 | 89 |
| | | coating | | | | | | | | |
| example 6 | — | Titan oxide | 54 | 57 | 9.9 | 375 | 3.20 | 72 | 32 | 89 |
| | | coating | | | | | | | | |
| example 7 | — | Zirconia | 55 | 58 | 9.8 | 274 | 2.91 | 69 | 34 | 87 |
| | | coating | | | | | | | | |
| example 8 | — | Silica coating | 56 | 63 | 8.6 | 218 | 2.82 | 68 | 35 | 88 |
| example 9 | Alumina | Alumina | 42 (positive | 56 (positive | 7.1 (positive | 286 | 3.45 | 74 | 38 | 92 |
| | coating | coating | electrode) | electrode) | electrode) | | | | | |
| | | | 53 (negative | 59 (negative | 9.5 (negative | | | | | |
| | | | electrode) | electrode) | electrode) | | | | | |
| example 10 | Titan | Titan oxide | 45 (positive | 63 (positive | 7.7 (positive | 286 | 3.52 | 75 | 36 | 92 |
| | oxide | coating | electrode) | electrode) | electrode | | | | | |
| | coating | | 54 (negative | 57 (negative | 9.9 (negative | | | | | |
| | | | electrode) | electrode) | electrode) | | | | | |
| example 11 | Zirconia | Zirconia | 43 (positive | 75 (positive | 7.6 (positive | 275 | 3.71 | 77 | 37 | 91 |
| | coating | coating | electrode) | electrode) | electrode) | | | | | |
| | | | 55 (negative | 58 (negative | 9.8 (negative | | | | | |
| | | | electrode) | electrode) | electrode) | | | | | |
| example 12 | Silica | Silica coating | 42 (positive | 65 (positive | 8 (positive | 288 | 3.43 | 75 | 38 | 94 |
| | coating | | electrode) | electrode) | electrode) | | | | | |
| | | | 56 (negative | 63 (negative | 8.6 (negative | | | | | |
| | | | electrode) | electrode) | electrode) | | | | | |

The comparative example represents a battery that was manufactured by forming a positive electrode and an negative electrode using a normal positive electrode active material, a negative electrode active material, a binder and a solvent, and installing a polyethylene (PE) film separator. A ceramic layer was not coated on the positive electrode and negative electrode plates.

The positive electrode and negative electrode of the examples 1 to 4 are the same electrode plates as the comparative example except that ceramic layers formed of alumina (Al₂O₃), titanium oxide (TiO₂), zirconia (ZrO₂) and silica (SiO₂) are respectively coated on the positive electrodes.

The positive electrode and negative electrode of the examples 5 to 8 are the same electrode plates as the comparative example except that ceramic layers formed of alumina (Al₂O₃), titanium oxide (TiO₂), zirconia (ZrO₂) and silica (SiO₂) are respectively coated on the positive electrodes.

The positive electrode and negative electrode of the examples 9 to 12 are the same electrode plates as the comparative example except that ceramic layers formed of alumina (Al₂O₃), titanium oxide (TiO₂), zirconia (ZrO₂) and silica (SiO₂) are respectively coated on the both electrode plates.

First, a semi-finished product evaluation was performed before manufacture of the battery for determining electrolyte wettability of electrode plates of the various examples. More particularly, 0.3 g of an electrolyte was dropped from height of 1 cm above of the electrode plate. Then, after 10 seconds, a diameter of the electrolyte spread in a circular shape was measured. In the examples 1 to 12, the diameter of the spread electrolyte is larger than the comparison example. The wider the electrolyte spread, then the more quickly the electrolyte is absorbed. Thus, each example including the ceramic layer has wettability for electrolyte larger than the comparative example including an olefin type film separator.

An end of the electrode plate was hung in a longitudinal direction so as to be dipped into the electrolyte by 1 mm to 2 mm from a surface of the electrolyte. Chromatography was performed during 5 minutes and then the permeation height of the electrolyte was measured. The higher the electrolyte permeates, then the more quickly the electrolyte is absorbed and thus, the wettability of the electrode plate is good. The permeation height of the electrolyte in the examples 1 to 12 is higher than the comparative example.

On the other hand, the whole electrode plate was immersed in the electrolyte so as to be covered sufficiently and, was taken out after 10 seconds. Then the weight increase of the electrode plates was measured. A maximum amount of the electrolyte which the electrode plate can absorb can be identified by the test. The larger the weight increase is, then the better the electrolyte holding property of the electrode plate. In the examples 1 to 12, the weight increase of the electrode plate is larger than the comparative example. As a result of comparison of wettability of the electrode plate before manufacture of a battery by the test above, it can be identified that wettability of the electrode plate is excellent when the ceramic layer is on the electrode plate.

Furthermore, a rectangular battery was manufactured and an electrolyte injecting speed of the battery was compared with an actual battery. After an electrolyte injection hole of the rectangular battery is fitted in a zig, 3 g of the electrolyte is injected into an upper part of the zig and then the rectangular battery fitted in the zig was put in a vacuum chamber in an open state. After the chamber was vacuumed to 10mbar, air was supplied into the chamber so as to correspond to atmospheric pressure. Then a time for which all of the electrolyte in the zig had been injected into the battery was measured. The faster the injecting speed is, the better the productivity.

On the other hand, a battery was manufactured and an electrolyte injecting amount for a predetermined time was compared. After an electrolyte injection hole of the rectangular battery is fitted in a zig, the electrolyte of excess amount of 5 g is injected into an upper part of the zig and then the rectangular battery fitted in the zig was put in a vacuum chamber in opened state. After the chamber was vacuumed to 10 mbar, air was supplied into the chamber so as to correspond to atmospheric pressure. After the electrolyte in the zig was injected into the battery for 3 minutes, the injected amount was checked. The amount of the electrolyte that can inject for a predetermined time can be determined by the test. The more the electrolyte is injected for a predetermined time, the shorter the injecting time becomes, thereby allowing productivity to be improved. The more the electrolyte is in the battery, the better the cycle capacity of the battery. The batteries using the electrode plates of the examples 1 to 12 have a higher injecting speed and a greater injecting amount than the comparative example.

Furthermore, after the battery had been high-rate charged by 2 C/4.2V 10mA cut off under CC/CV condition, then the battery was high-rate discharged by 5 C/3V cut off under CC constant current condition. The measured discharge capacity of the battery was represented by % to 1 C charge/discharge capacity. The expression of “the battery was high-rate charged by 2 C/4.2V 10 mA cut off under CC/CV condition, then was high-rate discharged by 5 C/3V cut off under CC constant current condition” means that the battery was high-rate charged to 4.2 V with 2 C-rate, which is twice of 1 C-rate, for 2 hours under constant current/constant voltage (CC/CV) condition, then the battery was high-rate discharged to 3 V with 5 C-rate, which is fivefold of 1 C-rate. In comparison with the discharge capacity 30% of the battery of the comparative example, the discharge capacities of the batteries of the examples 1 to 12 are more than 60%. Thus, the high rate charge/discharge property was improved by forming the ceramic layer instead of the olefin type film.

Furthermore, after the battery had been charged at room temperature of 23° C. by 1 C/4.2V 10 mA cut off under CC/CV condition and then left for more than 4 hours at −20° C., then the battery was discharged by 1 C/3V cut off under CC constant current condition. The measured discharge capacity of the battery was represented by % to 1 C charge/discharge capacity at room temperature of 23° C. In comparison with the discharge capacity 15% of the battery of the comparative example, the discharge capacities of the batteries of the examples 1 to 12 are more than 30%. Thus, the low temperature discharge property was more than doubled.

On the other hand, after the battery had been charged by 1 C/4.2V 10 mA cut off under CC/CV condition, the battery was charged/discharged more than 500 times by 1 C/3V cut off under CC constant current condition. The 500 times discharge capacity of the battery was represented by % to one time discharge capacity. In comparison with the cycle maintenance capacity 65% of the battery ofthe comparative example, the cycle maintenance capacities ofthe batteries ofthe examples 1 to 12 were more than 80%.

A secondary battery including the jelly roll electrode assembly is explained in detail below.

The secondary battery includes the jelly roll electrode assembly, a can for receiving the jelly roll electrode assembly and a cap assembly for sealing an open end of the can.

The jelly roll electrode assembly includes a positive electrode plate, an negative electrode plate and a separator, which is interposed between the positive electrode and negative electrode plates and laminated and wound. At one end of an non-coating portion of the positive electrode plate or the negative electrode plate, an extended contact part made of the same electrode material as an non-coating portion is formed so as to contact a mandrel at the time of winding. Furthermore, the separator is formed of a ceramic layer coated on at least one surface of the positive electrode plate or the negative electrode plate.

On the other hand, the can and cap assembly have general constructions of a secondary battery.

That is, the can is formed of aluminum or an aluminum alloy having a roughly rectangular shape. The electrode assembly is received through the open upper end of the can so that the can functions as the electrode assembly and a container for the electrolyte. The can may function as a terminal by itself.

The cap assembly includes a flat type cap plate having a size and a shape corresponding to the open upper end of the can. A tube-shaped gasket is provided between the cap plate and an electrode terminal passing through a center part of the cap plate for electrical insulation. An insulation plate is arranged on a lower surface of the cap plate, and a terminal plate is installed on a lower surface of the insulation plate. A lower surface of the electrode terminal is electrically coupled to the terminal plate. A positive electrode tap extending from a positive electrode plate is welded to the lower surface of the cap plate, and a negative electrode tap extending from a negative electrode plate is welded to a lower end of the electrode terminal with a zigzag-shaped bent part.

An electrolyte injection hole is formed on one side of the cap plate, and a stopper is installed to seal the injection hole after the electrolyte has been injected into the can. The stopper is formed by mechanically pressing a ball-shaped host material made of aluminum or an aluminum containing metal on the electrolyte injection hole. The stopper is welded to the cap plate at a periphery of the electrolyte injection hole to seal it. The cap assembly is attached to the can by welding a peripheral part of the cap plate to a side wall of the can opening.

The operations of the jelly roll electrode assembly and the secondary battery including the assembly are explained in detail below.

As shown in FIGS. 1 and 2, a extended contact part 50 made of a copper foil, which is the same substrate as an negative electrode non-coating portion, is integrally formed at one end of the negative electrode non-coating portion of the negative electrode plate of the jelly roll electrode assembly. Accordingly, the extended contact part 50 is first wound so as to enable easy winding when a jelly roll is formed by a mandrel.

Furthermore, referring to FIG. 3, a polymer 60 is coated or a resin composition is attached on the extended contact part 50 so as to reduce friction between the jelly roll and the mandrel. Thus, the jelly roll can be easily separated from the mandrel after winding.

On the other hand, the separator is interposed between the positive electrode plate and the negative electrode plate. The separator is formed of only the ceramic layer coated on at least one surface of the positive electrode plate or negative electrode plate. The highly porous ceramic layer is coated on one or both of the positive electrode and the negative electrode, thereby improving the electrolyte injecting property and electrolyte holding property. Furthermore, the ceramic layer quickly absorbs the electrolyte due to its high porosity and thus the electrolyte is quickly injected. The ceramic layer interposed between the electrode plates absorbs the electrolyte existing in a periphery of the jelly-roll and maintains it between the positive electrode and negative electrode layers, thereby improving the cycle characteristics.

As described above, the jelly roll electrode assembly and the secondary battery including the assembly according to the present invention produce the following effects.

First, the non-coating portion of the electrode plates are formed long instead of the film separator and thus, the winding becomes easy.

Second, the wound electrode assembly is easily separated from a mandrel so as to prevent a cross-winding phenomenon of the electrode assembly and the mandrel, thereby improving reliability.

Third, the separator for insulating the positive electrode plate from the negative electrode plate is formed of only the ceramic layer having high porosity, ion conductivity and electrolyte holding property, thereby improving the high rate charge/discharge property, low temperature discharge property and cycle property.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as being limitations of the present invention.

What is claimed is:

1. A jelly roll electrode assembly including a positive electrode plate and a negative electrode plate, the assembly comprising:
a ceramic layer coating at least one of the positive electrode plate or the negative electrode plate to prevent an electrical short between the positive electrode and negative electrode plates;
a non-coating portion arranged on both the positive electrode and negative electrode plates, the non-coating portion having no coated material; and
an extended contact part of the same electrode material as the non-coating portion, the extended contact part extending from one end of the non-coating portion of either the positive electrode plate or the negative electrode plate to contact a mandrel during winding of the assembly.

2. The jelly roll electrode assembly of claim 1, wherein the extended contact part has length to be wound from 1 to 3 times during winding of the assembly.

3. The jelly roll electrode assembly of claim 2, wherein the extended contact part has a length in a range of 1 cm to 10 cm.

4. The jelly roll electrode assembly of claim 1, wherein a polymer coats the extended contact part.

5. The jelly roll electrode assembly of claim 1, wherein a resin insulator is attached to the extended contact part.

6. The jelly roll electrode assembly of claim 1, wherein the ceramic layer is coated on either the positive electrode plate or the negative electrode plate and includes a ceramic paste including an inorganic oxide filler with a binder and a solvent.

7. The jelly roll electrode assembly of claim 6, wherein the inorganic oxide filler comprises a semiconductor filler including a band gap.

8. The jelly roll electrode assembly of claim 6, wherein the inorganic oxide filler comprises one of alumina (Al₂O₃) or zirconia (ZrO₂) or titanium oxide (TiO₂) or silica (SiO₂).

9. The jelly roll electrode assembly of claim 6, wherein the binder comprises an acrylate rubber group binder.

10. The jelly roll electrode assembly of claim 6, wherein the binder comprises a water-based binder corresponding to an organic binder of the coating portion coated on either the positive electrode plate or the negative electrode plate.

11. The jelly roll electrode assembly of claim 10, wherein the water-based binder comprises a SBR group binder.

12. The jelly roll electrode assembly of claim 10, wherein a solvent to be mixed with the water-based binder comprises NMP or isopropyl alcohol or toluene or xilen.

13. The jelly roll electrode assembly of claim 6, wherein the binder comprises an organic binder corresponding to the water-based binder of the coating portion coated on either the positive electrode plate or the negative electrode plate.

14. The jelly roll electrode assembly of claim 13, wherein the organic binder comprises PVDF group binder.

15. The jelly roll electrode assembly of claim 13, wherein a solvent to be mixed with the organic binder comprises water.

16. A secondary battery including a jelly roll electrode assembly, a can and a cap assembly, the battery comprising:
a ceramic layer coating at least one of two electrode plates included in the jelly roll electrode assembly to prevent an electrical short between the two electrode plates, the two electrode plates each having a non-coating portion having no active material coated thereon; and
an extended contact part of the same electrode material as the non-coating portion, the extended contact part extending from one end of one non-coating portion of the two electrode plates to contact a mandrel during winding of the assembly.

17. A jelly roll electrode assembly comprising:
a first electrode plate and a second electrode plate; and
a ceramic layer coating at least one of the first and second electrode plates to prevent an electrical short between the first and second electrode plates;
wherein the first electrode plate and the second electrode plate each have a non-coated electrode portion and a coated electrode portion; and
wherein the electrode portion is arranged in an innermost portion of the electrode assembly, and has a length to be wound at least one time during winding of the assembly.

18. The jelly roll electrode assembly of claim 17, wherein the non-coated electrode portion arranged in the innermost portion of the electrode assembly has a length to be wound in a rage of from 1 to 3 times.

19. The jelly roll electrode assembly of claim 17, further comprising a polymer coating an inside of the non-coated electrode portion in the innermost portion of the electrode assembly.

20. The jelly roll electrode assembly of claim 17, further comprising a resin insulator attached to an inside of the non-coated electrode portion in the innermost portion of the electrode assembly.
